(19) United States
(12) Patent Application Publication
(10) Pub. No.: US 2006/0135633 A1
(43) Pub. Date: Jun. 22, 2006

(54) Porous low-dielectric constant (k) thin film with controlled solvent diffusion

(75) Inventors: Kwang Hee Lee, Suwon-Si (KR); Jin Heong Yim, Suwon-Si (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Samsung Corning Co., Ltd., Suwon-Si (KR)

(21) Appl. No.: 11/263,867

(22) Filed: Nov. 2, 2005

(30) Foreign Application Priority Data
Nov. 3, 2004 (KR) 2004-88803

(51) Int. Cl. C08J 9/00; C08L 63/00

(52) U.S. Cl. 521/50; 521/135; 521/77

(57) ABSTRACT

A porous low-dielectric constant thin film with controlled solvent diffusion into pores of the porous thin film. The porous thin film i s formed from a composition including a porogen containing at least one π-π interacting functional group, a thermostable matrix precursor, and a solvent dissolving the porogen and the matrix precursor. The porous thin film thus formed has mesopores not smaller than 10 nm in size and has a solvent diffusion rate not higher than 30 μm²/sec. Due to the presence of the large pores, the porous thin film can greatly inhibit solvent diffusion into the pores of the thin film, which is encountered during wet processes, without substantial changes in dielectric constant, elastic modulus and hardness depending on the porosity of the thin film.

### CROSS-REFERENCE TO RELATED PATENT APPLICATION

This non-provisional application claims priority under 35 U.S.C. § 119(a) on Korean Patent Application No. 2004-88803 filed on Nov. 3, 2004, which is herein incorporated by reference.

### BACKGROUND OF THE INVENTION

1. Field of the Invention

Embodiments of the present invention relate to a porous low-dielectric constant thin film with controlled solvent diffusion into pores of the porous thin film, and more particularly to a porous thin film formed from a composition comprising a pore-forming agent (i.e. porogen) containing at least one π-π interacting functional group, a thermostable matrix precursor, and a solvent dissolving the porogen and the matrix precursor wherein the porous thin film has mesopores not smaller than 10 nm in size and has a solvent diffusion rate not higher than 30 μm²/sec.

2. Description of the Related Art

In recent years, materials having nano-sized pores have drawn attention as materials for adsorbents, supports for catalysts, thermal insulators and electrical insulators in various fields. With the increasing integration of semiconductor devices, the speed between wirings has a significant impact on the performance of the semiconductor devices. Accordingly, an interlayer dielectric film having a low storage capacity is required in order to lower the resistance and capacity between wirings. For this purpose, attempts have been made to use low dielectric constant materials for interlayer dielectric films. For instance, U.S. Pat. Nos. 3,615,272, 4,399,266 and 4,999,397 disclose methods for forming semiconductor interlayer dielectric films by using polysilsesquioxanes with a dielectric constant of about 2.5-3.1 which can be applied by spin-on deposition (“SOD”), instead of SiO₂ having a dielectric constant of around 4.00 applied by conventional chemical vapor deposition (CVD). Further, U.S. Pat. No. 5,965,679 teaches a method for forming a semiconductor interlayer dielectric film by using a polyphenylene as an organic polymer with a dielectric constant between about 2.65 and about 2.7. However, this dielectric constant range is not sufficiently low to satisfy an increasing demand to fabricate high-speed devices requiring an ultra-low dielectric constant not higher than 2.50.

To overcome these limitations, there have been a number of trials to incorporate air having a dielectric constant of 1.0 at the nanometer-scale level into an organic or inorganic material. A method is known for forming a nanoporous silica (SiO₂) using tetraethoxysilane (“TEOS”) and an appropriate pore-forming agent (i.e. porogen) by a sol-gel process. According to the method taught in U.S. Pat. No. 6,114,458, a lactone-based polymer in a dendrimeric form which can be decomposed during heating for the formation of a thin film is used as a porogen. A further method for preparing a material having a dielectric constant κlower than 3.0 is found in U.S. Pat. Nos. 6,107,357 and 6,093,636. According to this method, first, a particular amount of the lactone-based polymer and a vinyl-based polymer, e.g., polystyrene, polymethacrylate or polyester, in a dendrimeric form are mixed with an organic or inorganic matrix to form a thin film, and are then decomposed at high temperatures to form nano-scale pores.

U.S. Pat. Nos. 6,645,878, 6,448,331, 6,380,105, 6,319,852, 6,255,156 and 6,309,945 disclose low dielectric constant thin films having nanopores wherein the nanopores have a uniform size distribution.

Namely, according to the prior art methods, since the porous low-dielectric constant thin films are formed by wet processes, exposure to solvents is inevitable. As a result, the solvents are diffused into the pores of the porous thin films, leading to a deterioration in the characteristics of the porous thin films. Thus, there exists a need to develop a technique for controlling solvent diffusion into pores of a porous thin film in terms of improved physical properties of the porous thin film, e.g., low dielectric constant.

### OBJECTS AND SUMMARY

Therefore, embodiments of the present invention have been made to satisfy the above-mentioned technical need, and it is an object of embodiments of the present invention to provide a porous thin film with controlled solvent diffusion into pores of the porous thin film while maintaining mechanical properties, e.g., dielectric constant, elastic modulus and hardness, according to the changes in the porosity of the porous thin film.

In accordance with one aspect of embodiments of the present invention for achieving the above object, there is provided a porous thin film formed from a composition comprising a porogen containing at least one π-π interacting functional group, a thermostable matrix precursor, and a solvent dissolving the porogen and the matrix precursor wherein the porous thin film has mesopores not smaller than 10 nm in size and has a solvent diffusion rate not higher than 30 μm²/sec.

### BRIEF DESCRIPTION OF THE DRAWINGS

The above and other objects, features and other advantages of embodiments of the present invention will be more clearly understood from the following detailed description taken in conjunction with the accompanying drawings, in which:

FIG. 1 is a graph showing changes in dielectric constant, elastic modulus and hardness according to the porosity of thin films formed in Examples 1 to 4;

FIG. 2 is a cross-sectional scanning electron micrograph (SEM) of a thin film formed in Example 2, measured at 20 kV using an SEM S-4500;

FIG. 3 is a cross-sectional scanning electron micrograph (SEM) of a thin film formed in Example 3, measured at 20 kV using an SEM S4500;

FIG. 4 is a cross-sectional scanning electron micrograph (SEM) of a thin film formed in Example 4, measured at 20 kV using an SEM S-4500;

FIG. 5 is a cross-sectional scanning electron micrograph (SEM) of a thin film formed in Comparative Example 4, measured at 20 kV using an SEM S4500; and

FIG. 6 is a cross-sectional scanning electron micrograph (SEM) of a thin film formed in Example 5, measured at 20 kV using an SEM S-4500.

### DETAILED DESCRIPTION OF THE PREFERRED EMBODIMENTS

Hereinafter, embodiments of the present invention will be described in more detail.

A porous thin film with controlled solvent diffusion according to embodiments of the present invention may be formed from a composition comprising a porogen containing at least one π-π interacting functional group, a thermostable matrix precursor, and a solvent dissolving the porogen and the matrix precursor.

The porogen contained in the composition used to form the porous thin film of embodiments of the present invention may have a structure in which a thermally decomposable organic material core is positioned in the center and at least one π-π interacting functional group is positioned at the terminal of the porogen.

A preferred porogen containing at least one π-π interacting functional group is a cyclodextrin derivative represented by Formula 1 below: 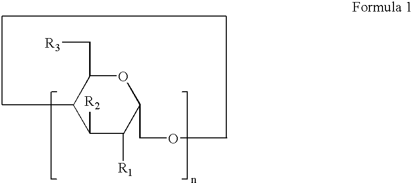
wherein n is an integer of 3 or greater; R₁, R₂ and R₃ are independently benzoyl, phenyl, cyclopentadienyl, OH, SH, NH₂, or —OR₄,

in which R₄ is a C₂-C₃₀ acyl group, a C₂-C₂₀ alkyl group, a C₃-C₁₀ cycloalkyl group, a C₁-C₂₀ hydroxyalkyl group, carboxyl, or a silicon (Si) compound represented by Sir₁r₂r₃,

in which r₁, r₂ and r₃ are independently a C₁-C₅ alkyl group, a C₁-C₅ alkoxy group, or a C₆-C₂₀ aryl group,

with the proviso that at least one of R₁, R₂, and R₃ is benzoyl, phenyl, or cyclopentadienyl.

Another preferred porogen containing at least one π-π interacting functional group is a sucrose derivative represented by Formula 2 below:

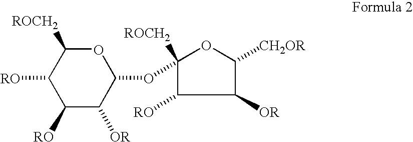

wherein R is benzoyl, phenyl, or cyclopentadienyl.

Despite the use of a small amount of the porogen, mesopores having a size not smaller than 10 nm may be formed in the porous thin film of embodiments of the present invention due to the presence of at least one π-π interacting functional group at the terminal of the porogen. When compared to conventional porous thin films having a pore size of less than 10 nm but a porosity substantially equal to that of the porous thin film according to embodiments of the present invention, the porous thin film of embodiments of the present invention may greatly control solvent diffusion into the pores while providing physical properties comparable to those of the conventional porous thin films.

The thermostable matrix precursor contained in the composition used to form the porous thin film of embodiments of the present invention may be an inorganic or organic polymer having a glass transition temperature (T_{g}) of at least 400° C.

Examples of the inorganic polymer include (1) silsesquioxanes, (2) condensation products of alkoxysilanes, (3) organic silicates whose composition RSiO₃ or R₂SiO₂ (wherein R is an alkyl group, such as methyl, ethyl, or propyl) is organically modified, and (4) partially condensed orthosilicates having the composition SiOR₄ (wherein R is an alkyl group, such as methyl, ethyl, or propyl).

The silsesquioxanes derived from organic polysiloxanes may be exemplified by hydrogen silsesquioxane, alkyl silsesquioxanes, aryl silsesquioxanes, and copolymers of these silsesquioxanes. Examples of the alkyl silsesquioxanes include, but are not limited to, methyl silsesquioxane, ethyl silsesquioxane, and propyl silsesquioxane. Examples of the aryl silsesquioxanes include, but are not limited to, phenyl silsesquioxane. As copolymers of the silsesquioxanes, there may be used, without limitation, copolymers of hydrogen silsesquioxane and phenyl silsesquioxane, copolymers of methyl silsesquioxane and ethyl silsesquioxane, and copolymers of methyl silsesquioxane and vinyl silsesquioxane.

The condensation products of alkoxysilanes refer to materials prepared by partial condensation of alkoxysilanes to a number-average molecular weight of 500-20,000. As such alkoxysilanes, there may be mentioned, for example, tetraethoxysilane, and tetramethoxysilane.

In addition, as the thermostable organic matrix precursor, there can be used an organic polymer that can be cured at high temperatures to form a stable reticular structure. Specific examples of the organic polymer include polyimide-based polymers which can undergo imidization, such as poly(amic acid) and poly(amic acid ester); polybenzocyclobutene-based polymers; and polyarylene-based polymers, such as polyphenylene and poly(arylene ethers).

The matrix precursor is more preferably a highly soluble organic polysiloxane-based resin having a silanol group (Si—OH) content of at least 10 mole % and preferably at least 25 mole %, which is prepared by hydrolysis and condensation of a cyclic siloxane monomer in the presence of an appropriate catalyst. When the Si—OH content is at least 10 mole %, the composition used in embodiments of the present invention shows not only satisfactory mechanical strength but also good compatibility with the cydodextrin derivative.

The cyclic siloxane monomer used to prepare the matrix precursor may be a compound wherein silicon atoms are linked to each other via oxygen atoms to form a cyclic structure, and the end of each branch contains organic groups constituting a hydrolyzable substituent. The cyclic siloxane monomer may be represented by Formula 3 below:

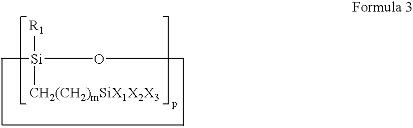

wherein R₁ is a hydrogen atom, a C₁-C₃ alkyl group, or a C₆-C₁₅ aryl group; X₁, X₂ and X₃ are independently a hydrogen atom, a C₁-C₃ alkyl group, a C₁-C₁₀ alkoxy group, or a halogen atom, at least one of these substituents being a hydrolyzable functional group; m is an integer ranging from 1 to 10; and p is an integer ranging from 3to 8; or

Formula 4 below:

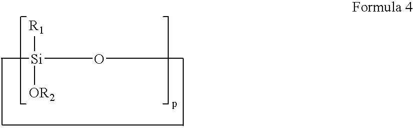

wherein R₁ is a hydrogen atom, a C₁-C₃ alkyl group, or a C₆-C₁₅ aryl group; R₂ is a hydrogen atom, a C₁-C₁₀ alkyl group, or SiX₁X₂X₃,

in which X₁, X₂ and X₃ are independently a hydrogen atom, a C₁-C₃ alkyl group, a C₁-C₁₀ alkoxy group, or a halogen atom;

and p is an integer between 3 and 8.

The method for preparing the cyclic siloxane monomers is not specifically limited, but hydrosililation using a metal catalyst is preferred.

As suitable cyclic siloxane monomers, commercially available siloxane monomers whose terminal functional groups are halogen atoms may be used without any modification or after converting the terminal halogen atoms into alkyl or alkoxy groups. Such a conversion method is not specifically limited as long as it does not impair the objects of embodiments of the present invention, and may be one previously known in the art. For example, conversion of terminal halogen atoms into alkoxy groups can be carried out by reacting the siloxane monomers with alcohol and triethylamine.

One example of the siloxane monomer having an organic bridge of Formula 3 is preferably the monomer of Formula 5 below:

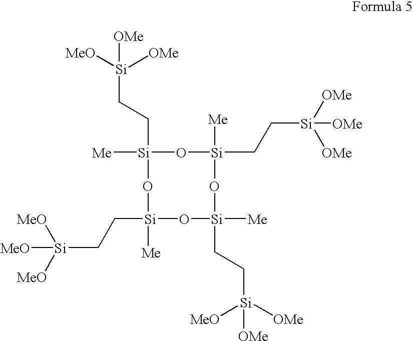

Conditions for the hydrolysis and condensation during preparation of the matrix precursor may be as follows. The acid catalyst used herein is not specifically limited, but is preferably hydrochloric acid, benzenesulfonic acid, oxalic acid, nitric acid, formic acid, or a mixture thereof.

The equivalence ratio of the water used during the hydrolysis and condensation to reactive groups present in the monomers may be in the range of 1.0-100.0:1, and preferably 1.0-10.0:1. The reaction may be carried out at 0-200° C. and preferably 50-110° C. for 1-100 hrs and preferably 5-48 hrs.

The composition used in embodiments of the present invention may be prepared by dissolving the porogen containing at least one π-π interacting functional group and the thermostable matrix precursor in an appropriate solvent. The content of the porogen may be in the range of 0. 1%-95% by weight, and preferably 1 0%-70% by weight, based on the total solid content (i.e. the sum of the amounts of the porogen and the matrix precursor).

Examples of the solvent used in embodiments of the present invention include, but are not limited to, aromatic hydrocarbons, such as anisole, xylene, and mesitylene; ketones, such as methyl isobutyl ketone, 1-methyl-2-pyrrolidinone, and acetone; ethers, such as tetrahydrofuran, and isopropyl ether; acetates, such as ethyl acetate, butyl acetate, and propylene glycol monomethyl ether acetate; amides, such as dimethylacetamide, and dimethylformamide; γ-butyrolactone; alcohols, such as isopropyl alcohol, butyl alcohol, and octyl alcohol; silicon solvents; and mixtures thereof.

The solvent should be used in an amount sufficient to dissolve the matrix precursor up to a concentration required for application on a substrate. The solvent may be present in the range of 20%-99.9% by weight and preferably 70%-95% by weight in the composition.

A detailed explanation of a method for forming the porous thin film with controlled solvent diffusion according to embodiments of the present invention will be provided below.

First, the composition of embodiments of the present invention may be applied to a substrate by spin coating, dip coating, spray coating, flow coating, screen printing, or so on. The application is preferably carried out by spin coating at a speed of 1,000-5,000 rpm. After coating, the organic solvent is evaporated from the coated substrate to deposit a resinous film on the substrate. The evaporation may be carried out by exposing the coated substrate to atmosphere (simple air-drying), subjecting the substrate to vacuum conditions at the initial stage of subsequent curing step, or mild heating at 100° C. or lower.

The resulting coating film may be cured by heating to a temperature of 150° C.-600° C., preferably 200° C.-450° C. at which pyrolysis of the porogen occurs, thereby providing a crack-free insoluble film. The term “crack-free film” as used herein refers to a film without any crack when observed under an optical microscope at a magnification of 1,000×. The term “insoluble film” as used herein refers to a film which is substantially insoluble in any solvent described as being useful for the coating and deposition of the siloxane-based resin. The heat-curing of the coating film may be performed under an inert gas (nitrogen, argon, etc.) atmosphere or vacuum for up to 10 hrs, and preferably 0.5-1 hr.

Following the heat-curing, mesopores having a size not smaller than 10 nm are preferably formed, leading to a porous thin film with controlled solvent diffusion. For example, diffusion of non-polar solvents (e.g., toluene) and polar solvents (e.g., methanol) into the porous thin film is preferably limited to 30 μm²/sec. or lower. Fine pores having a size of 1.5 nm or less may be formed within the porous thin film, which can act to connect the separated mesopores. The fine pores are free volumes formed between interatomic or intermolecular bonds. The presence of the fine pores further inhibits the solvent diffusion.

The porous thin film of embodiments of the present invention may have a low dielectric constant, and is thus applicable to low-dielectric constant materials for semiconductors that may be exposed during wet processes. Further, since the porous thin film of embodiments of the present invention preferably control the solvent diffusion rate to 30 μm²/second or lower, it may be applied to many industrial applications where high-porosity films may be exposed to wet chemical solvents, particularly, construction materials.

Embodiments of the present invention will now be described in more detail with reference to the following examples. However, these examples are given for the purpose of illustration and are not to be construed as limiting the scope of the invention.

### SYNTHESIS EXAMPLE 1

### Synthesis of Precursor Monomer “a”

29.014 mmol (10.0 g) of 2,4,6,8-tetramethyl-2,4,6,8-tetravinylcyclotetrasiloxane and 0.164 g of a solution of platinum(0),1,3-divinyl-1,1,3,3-tetramethyidisiloxane complex in xylene were put into a flask, and then 300 ml of diethyl ether was added thereto to dilute the mixture. After the mixture was cooled to −78° C., 127.66 mmol (17.29 g) of trichlorosilane was slowly added to the mixture. The reaction temperature was gradually raised to room temperature. The reaction was continued for 20 hours at room temperature. After completion of the reaction, volatile substances were completely evaporated at a reduced pressure of about 0.1 torr and 100 ml of pentane was added to the concentrate. The resulting mixture was stirred for 1 hour. The mixture was filtered through celite, and then the pentane was evaporated at reduced pressure (−0.1 torr) to obtain a reaction product ([—Si(CH₃)(CH₂CH₂SiCl₃)O—]₄) as a colorless liquid in a yield of 95%.

Next, 11.28 mmol (10.0 g) of the reaction product was diluted in 500 ml of tetrahydrofuran, and then 136.71 mmol (13.83 g) of triethylamine was added thereto. After the mixture was cooled to −78° C., 136.71 mmol (4.38 g) of methyl alcohol was slowly added thereto. The reaction temperature was gradually raised to room temperature. The reaction was continued for 15 hours at room temperature. After completion of the reaction, the reaction mixture was filtered through celite, and then the obtained filtrate was concentrated at reduced pressure of about 0.1 torr to completely evaporate volatile substances. 100 ml of pentane was added to the concentrate. The resulting mixture was stirred for 1 hour. The mixture was filtered through celite, and then the pentane was evaporated at reduced pressure (approximately 0.1 torr) to prepare monomer “a” of Formula 5 as a colorless liquid:

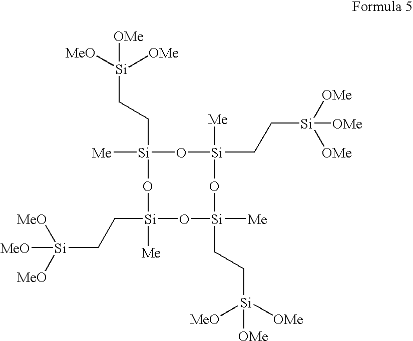

The analytical results of the ¹H-NMR spectrum (300 MHz, acetone-d₆) of the monomer “a” are as follows: δ 0.09 (s, 12H, 4×[CH₃]), 0.52-0.64 (m, 16H, 4×[—CH₂CH₂—]), 3.58 (s, 36H, 4×[—OCH₃]₃).

### SYNTHESIS EXAMPLE 2

### Synthesis of Precursor Monomer “b”

41.6 m mole (10.00 g) of 2,4,6,8-tetramethyl-2,4,6,8-cyclotetrasiloxane was placed into a flask, and then 100 ml of tetrahydrofuran was added thereto to prepare a dilution. 700 mg of 10 wt % palladium/charcoal (Pd/C) was added to the dilution, followed by the addition of 177.8 mmol (3.20 ml) of distilled water. At this time, hydrogen gas evolved during the addition was removed. The resulting mixture was allowed to react at room temperature for 5 hours. The reaction solution was sequentially filtered through celite and MgSO₄. Volatile substances were completely evaporated at a reduced pressure of about 0.1 torr and then 41.6 mmol (12.6) of the obtained compound was diluted in 200 ml of tetrahydrofuran. To the dilution was added 177.8 mmol (13.83 g) of triethylamine. After the resulting solution was cooled to −0° C., 177.8 mmol (25.0 g) of chlorotrimethoxysilane was slowly added. The temperature was slowly elevated to room temperature. The reaction was allowed to proceed for 12 hours. The reaction solution was filtered through celite, and concentrated at reduced pressure (approximately 0.1 torr) to remove volatile substances, affording monomer “b” of Formula 6 as a colorless liquid.

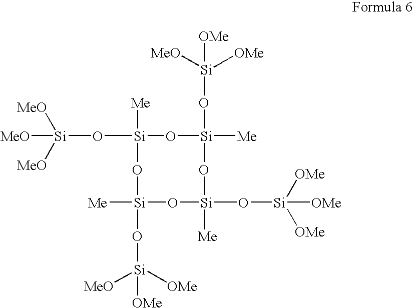

The analytical results of the ¹H-NMR spectrum (300 MHz) of the monomer “b” are as follows: δ 0.092 (s, 12H, 4×[—CH₃]), 3.58 (s, 36H, 4×[—OCH₃]₃).

### PREPARATIVE EXAMPLE 1

### Homopolymerization of Precursor Monomer “a”

9.85 mmol (8.218 g) of the monomer “a” prepared in Synthesis Example 1 was diluted in 90 ml of tetrahydrofuran in a flask. Separately, water and concentrated hydrochloric acid (containing 35% hydrogen chloride) were mixed in a ratio of 100:8.8 (v/v) to prepare hydrochloric acid in which the hydrogen chloride was present in an amount of 1.18 mmol. The hydrochloric acid thus prepared was slowly added to the previous monomer mixture, and then 393.61 mmol (8.084 g) of water, including water contained in the hydrochloric acid, was slowly added thereto. The reaction temperature was gradually increased to 70° C. At this temperature, the reaction was continued for 16 hours. The reaction solution was transferred to a separatory funnel, and then 90 ml of diethyl ether was added thereto, followed by washing with water (100 ml×5) and the addition of anhydrous sodium sulfate (5 g). The resulting mixture was stirred at room temperature for 10 hours to remove the small quantity of water that remained, and filtered to obtain a colorless clear solution. The solution was concentrated at reduced pressure (about 0.1 torr) to remove volatile substances, affording 5.3 g of precursor “A” as a white powder. The contents (%) of Si—OH, Si—OCH₃ and Si—CH₃ in the precursor “A” were determined by ¹H-NMR analysis. Specifically, the respective contents were obtained by substituting the areas under the characteristic peaks into the following Equations 1 through 3 below:
Si—OH(%)=Area(Si—OH)÷[Area(Si—OH)+Area(Si—OCH₃)/3+Area(Si—CH₃)/3]×100 [Equation 1]
Si—OCH₃(%)=Area(Si—OCH₃)/3÷[Area(Si—OH)+Area(Si—OCH₃)/3+Area(Si—CH₃)/3]×100 [Equation 2]
Si—CH₃(%)=Area(Si—CH₃)/3÷[Area(Si—OH)+Area(Si—OCH₃)/3+Area(Si—CH₃)/3]×100 [Equation 3]

As a result, the contents of Si—OH (%), Si—OCH₃ and Si—CH₃ in the precursor “A” were 25.84%, 0.18%, and 73.98%, respectively. The molecular weight and molecular weight distribution of the precursor “A” were analyzed by gel permeation chromatography (Waters Co.). The analysis shows that the precursor “A” had a molecular weight of 20.125 and a molecular weight distribution of 3.13.

### PREPARATIVE EXAMPLE 2

### Copolymerization of Precursor Monomer “b” and Methyltrimethoxysilane (MTMS)

5.09 mmol of the multi-functional siloxane monomer “b” in Synthesis Example 2 and 45.81 mmol of methyltrimethoxysilane (MTMS, Aldrich) were placed into a flask, and were then diluted in tetrahydrofuran until the dilution concentration reached 0.05-0.07 M. The reaction solution was cooled to −78° C. After 1.985 mmol of hydrochloric acid and 661.6 mmol of water were added to the flask, the reaction temperature was gradually raised to 70° C. At this temperature, the reaction was continued for 16 hours. The reaction solution was transferred to a separatory funnel, followed by the addition of diethyl ether and tetrahydrofuran in the same amounts as the first amount of tetrahydrofuran. The resulting mixture was washed three times with water in the amount of one tenth of the total volume of the solvents used, and was then evaporated at reduced pressure to remove volatile materials, giving a polymer as a white powder. The polymer was dissolved in tetrahydrofuran until it became transparent, and passed through a filter (pore size: 0.2 μm). Water was slowly added to the filtrate to obtain a precipitate as a white powder. The precipitate was dried under 0.1 torr at 0-20° C. for 10 hours to afford a siloxane-based polymer (“B”). The contents of Si—OH, Si—OCH₃ and Si—CH₃ in the polymer were measured to be 28.20%, 0.90%, and 70.90%, respectively (the contents were determined following the same procedure as in Preparative Example 1).

### EXAMPLES 1 to 4

### Formation of Thin Films having Various Pore Sizes

The siloxane-based resin matrix precursor A prepared in Preparative Example 1, heptakis(2,3,6-tri-O-benzoyl)-β-cyclodextrin (hereinafter, referred to as “bCD”) as a porogen, and propylene glycol methyl ether acetate were mixed together in accordance with the particular ratios indicated in Table 1 below to prepare corresponding compositions for the formation of porous thin films.

These compositions were spin-coated on different boron-doped p-type silicon wafers at 3,000 rpm. Then, the wafers were sequentially soft-baked on a hot plate coated with a siloxane-based resin at 150° C. for one minute and at 250° C. for one minute, to completely remove organic solvents. The baked substrates were cured in a Linberg furnace under vacuum at 420° C. for 60 minutes to form thin films.

### EXAMPLE 5

A thin film was formed in the same manner as in Examples 1 to 4, except that the precursor A (solid content: 24%) was used and 30% sucrose benzoate was used as a porogen instead of bCD. The cross-sectional SEM image of the thin film is shown in FIG. 6.

The size of the pores formed in the thin film was measured using an ellipsometric porosimeter (EP), which is an apparatus for measuring the size of nanopores, and as a result, the thin film was measured to have a pore size of about 10 nm to about 20 nm. No solvent diffusion experiment for the thin film was conducted. Since the porogen contains a benzoyl group and the pore shape of the thin film is similar to that of the thin films formed in Examples 1 to 4, which were formed using bCD as a porogen, the thin film formed in this example was thought to have a low diffusion coefficient.

### COMPARATIVE EXAMPLES 1 to 4

In these comparative examples, thin films were formed in the same manner as in Examples 1 to 4, except that the precursor B prepared in Preparative Example 2 was used instead of the precursor A, heptakis(2,3,6-tri-O-methyl)-β-cyclodextrin) (hereinafter, referred to as “tCD”) was used instead of bCD as a porogen, and the precursor and the porogen were mixed in accordance with the particular ratios indicated in Table 1. The thin films thus formed had a pore size quite different from that of the thin films formed in Examples 1 to 5. Then, the physical properties of the thin films were compared with those of the thin films formed in Examples 1 to 5. At this time, the solid content of the thin films was adjusted so as to have a thickness similar to that of the thin films formed in Examples 1 to 4.

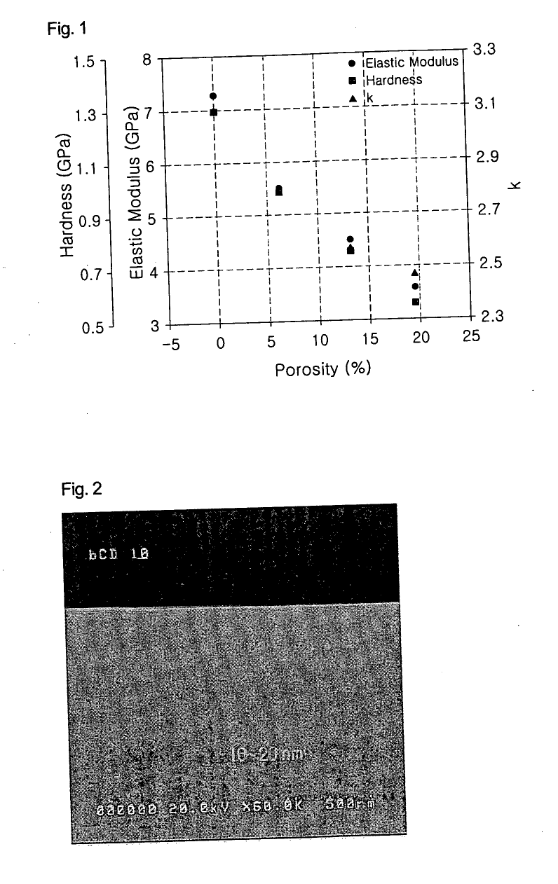

The physical properties of the thin films formed in Examples 1 to 4 and Comparative Examples 1 to 4 were evaluated, and the results are shown in Table 1 and FIG. 1.

<Measurements of Physical Properties>

1. Thickness and Refractive Index of Thin Film

The thickness and refractive index of the thin films were measured using a prism coupler.

2. Porosity

The porosity of the thin films was calculated from the measured refractive index using the Lorenz-Lorenz equation.

3. Dielectric Constant, Elastic Modulus and Hardness of Thin Films

The dielectric constant of the thin films was measured by the following procedure. First, metal-insulator-metal (MIM)-structured test pieces were produced using the thin films. The dielectric constant was measured at 100 kHz using an LCR METER (HP4284A) accompanied with a probe station. The modulus and hardness of the thin films were determined by a continuous stiffness measurement (CSM) using a nanoindenter II (MTS).

4. Pore Size of Thin Films

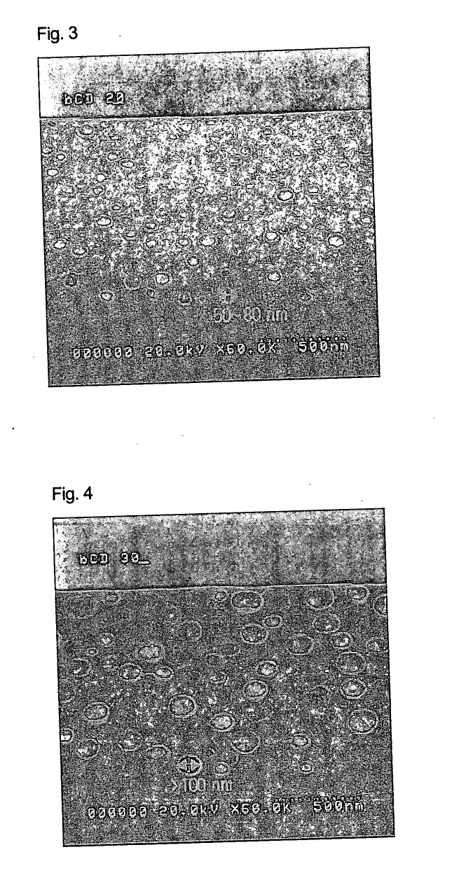

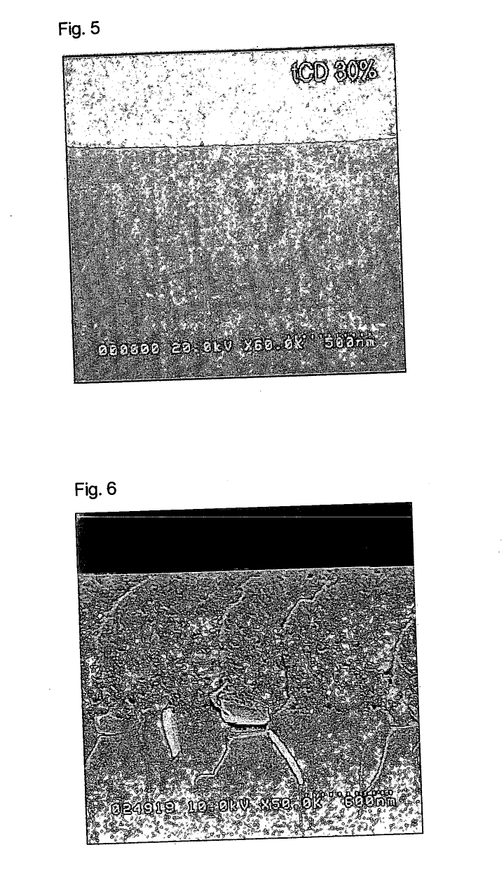

The cross-sectional SEM images of the thin films formed in Examples 2 to 4 and Comparative Example 4 were taken at 20 kV using an SEM S-4500, and the images are shown in FIGS. 2 to 5, respectively. Since no pore was observed in the thin film formed in Comparative Example 4, an ellipsometric porosimeter (EP), which is an apparatus for quantitatively measuring the size of nanopores, was used to measure the pore size of the thin film formed in Comparative Example 4. The measured pore sizes and methods employed for the measurement are shown in Table 1. Free volumes are formed between interatomic or intermolecular bonds within the thin films. The free volumes were measured as fine pores having a diameter of 1.5 nm or less.

5. Measurement of Solvent Diffusion Rate in Thin Films

SiN layers were formed on the thin films by chemical vapor deposition to have a thickness of 100 nm, and the resulting structures were cut into test pieces having dimensions of 1 cm×1 cm. A mixture of methanol as a polar solvent and toluene as a non-polar solvent was used as a diffusion medium. The solvent diffusion rate in the thin films was measured in accordance with the following procedure. First, the pieces were dipped in the diffusion medium. As the diffusion medium was permeated through the side walls of the pieces and diffused along the pores, the color of the thin films was changed. The diffusion length was recorded as a function of time. The diffusion coefficient was calculated by the following Equation 1:
L=2(Dt/π) Equation 1

where D is the diffusion coefficient (μm²/sec.), t is time in seconds, and L is the diffusion length (μm).

Since the thin films formed in Example 1 and Comparative Example 1 containing no porogen showed few or no changes in color with the passage of time, the diffusion coefficient was not obtained.

TABLE 1

| | Solid content | Porogens | | Thickness | | | Diffusion coefficient | | Pore size |
|---|---|---|---|---|---|---|---|---|---|
| | (%)(precursor + | | Content⁽²⁾ | of thin | Refractive | Porosity | (μm²/sec.) | | (Diameter |
| Example No. | porogen)⁽¹⁾ | Kind | (%) | films (nm) | Index | (%) | Toluene | Methanol | (nm)) |
| Example 1 | 24 | — | 0 | 1,161 | 1.4379 | — | — | — | — |
| Example 2 | 24 | bCD | 10 | 1,089 | 1.4069 | 6.228 | 0.82 | 1.543 | 10-20⁽³⁾ |
| Example 3 | 24 | bCD | 20 | 975 | 1.3731 | 13.174 | 0.024 | 1.188 | 50-80⁽³⁾* |
| Example 4 | 24 | bCD | 30 | 993 | 1.3429 | 19.519 | 0.071 | 1.762 | >100⁽³⁾* |
| Comparative | 30 | — | 0 | 901 | 1.3817 | — | — | — | — |
| Example 1 | | | | | | | | | |
| Comparative | 30 | tCD | 10 | 900 | 1.3465 | 8.311 | 69 | 148 | 1.72⁽⁴⁾ |
| Example 2 | | | | | | | | | |
| Comparative | 30 | tCD | 20 | 945 | 1.3183 | 15.112 | 159 | 257 | 2.08⁽⁴⁾ |
| Example 3 | | | | | | | | | |
| Comparative | 30 | tCD | 30 | 905 | 1.3016 | 19.200 | 510 | 424 | 2.50⁽⁴⁾* |
| Example 4 | | | | | | | | | |

In the above table,
⁽¹⁾: Weight percentage of the siloxane-based resinous matrix precursor and cyclodextrin compound as a porogen, based on the total weight of the composition (i.e., siloxane resinous matrix precursor+cyclodextrin compound+propylene glycol methyl ether acetate);
⁽²⁾: Weight percentage of the cyclodextrin compound in the solid content;
⁽³⁾: Pore sizes measured from cross-sectional SEM images (*: the cross-sectional SEM images are shown in figures);
⁽⁴⁾: Pore sizes measured by ellipsometric porosimetry (EP) (*: the cross-sectional SEM images are shown in figures).

As can be seen from the data shown in Table 1, the thin films having a pore size not smaller than 10 nm had a diffusion coefficient lower than 2 μm²/second. In contrast, the thin films formed in Comparative Examples 2 to 4 using tCD as a porogen had a diffusion coefficient about 100 times higher than that of the thin films formed in Examples 2 to 4.

As is evident from FIG. 1, the dielectric constant, elastic modulus and hardness were changed depending on the changes in porosity, irrespective of increase in pore size. Actually, as the porosity of the thin film increases, physical properties of the thin film grow worse additionally because of absorption of solvent into pores. However, as can be seen from FIG. 1, the porous thin film of the present invention does not show additional change of physical properties, such as dielectric constant, etc. by making the pore size larger as the porosity increases, resulting in suppression of solvent diffusion into the pores.

As can be seen from FIGS. 2 to 5, the pore size was varied depending on the kind and content of the porogens used.

As apparent from the above description, the porous thin film of embodiments of the present invention may greatly inhibit solvent diffusion into pores of the thin film, which is encountered during wet processes, due to the presence of large pores therein, without substantial changes in dielectric constant, elastic modulus and hardness depending on the porosity of the thin film.

Although the preferred embodiments of embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A porous thin film formed from a composition comprising a porogen comprising at least one π-π interacting functional group, a thermostable matrix precursor, and a solvent dissolving the porogen and the matrix precursor,
wherein the porous thin film has mesopores not smaller than 10 nm in size and has a solvent diffusion rate not higher than 30 μm²/sec.

2. The porous thin film a cording to claim 1, wherein the porous thin film comprises pores having a size not larger than 1.5 nm and acting to connect the mesopores.

3. The porous thin film according to claim 1, wherein the porogen is a cyclodextrin derivative of Formula 1 below: 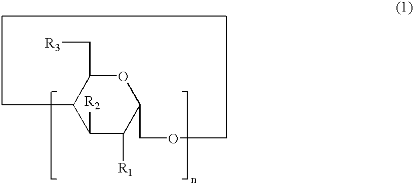
herein n is an integer of 3 or greater; R₁, R₂ and R₃ are independently benzoyl, phenyl, cyclopentadienyl, OH, SH, NH₂, or —OR₄,
in which R₄ is a C₂-C₃₀ acyl group, a C₂-C₂₀ alkyl group, a C₃-C₁₀ cydoalkyl group, a C₁-C₂₀ hydroxyalkyl group, carboxyl, or a silicon (Si) compound represented by Sir₁r₂r₃,
in which r₁, r₂ and r₃ are independently a C₁-C₅ alkyl group, a C₁-C₅ alkoxy group, or a C₆-C₂₀ aryl group,
with the proviso that at least one of R₁, R₂, and R₃ is benzoyl, phenyl, or cyclopentadienyl; or
a sucrose derivative of Formula 2 below: 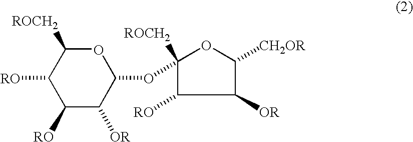
wherein R is benzoyl, phenyl, or cyclopentadienyl.

4. The porous thin film according to claim 2, wherein the porogen is a cyclodextrin derivative of Formula 1 below: 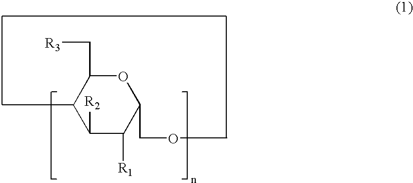
wherein n is an integer of 3 or greater; R₁, R₂ and R₃ are independently benzoyl, phenyl, cyclopentadienyl, OH, SH, NH₂, or —OR₄,
in which R₄ is a C₂-C₃₀ acyl group, a C₂-C₂₀ alkyl group, a C₃-C₁₀ cycloalkyl group, a C₁-C₂₀ hydroxyalkyl group, carboxyl, or a silicon (Si) compound represented by Sir₁r₂r₃,
in which r₁, r₂ and r₃ are independently a C₁-C₅ alkyl group, a C₁-C₅ alkoxy group, or a C₆-C20 aryl group,
with the proviso that at least one of R₁, R₂, and R₃ is benzoyl, phenyl, or cyclopentadienyl; or
a sucrose derivative of Formula 2 below: 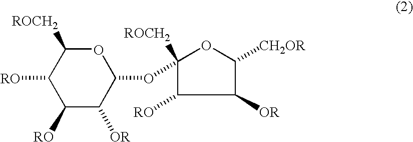
wherein R is benzoyl, phenyl, or cyclopentadienyl.

5. The porous thin film according to claim 1, wherein the thermostable matrix precursor is a siloxane-based resin prepared by hydrolysis and condensation of a compound represented by Formula 3 below: 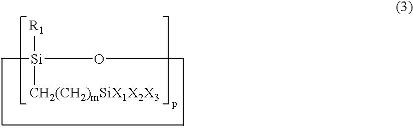
wherein R₁ is a hydrogen atom, a C₁-C₃ alkyl group, or a C₆-C₁₅ aryl group; X₁, X₂ and X₃ are independently a hydrogen atom, a C₁-C₃ alkyl group, a C₁-C₁₀ alkoxy group, or a halogen atom, at least one of these substituents being a hydrolyzable functional group; m is an integer ranging from 1 to 10; and p is an integer ranging from 3to8;or
Formula 4 below: 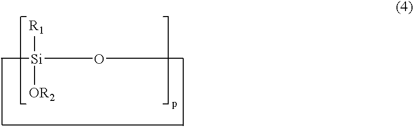
wherein R₁ is a hydrogen atom, a C₁-C₃ alkyl group, or a C₆-C₁₅ aryl group; R₂ is a hydrogen atom, a C₁-C₁₀ alkyl group, or SiX₁X₂X₃,
in which X₁, X₂ and X₃ are independently a hydrogen atom, a C₁-C₃ alkyl group, a C₁-C₁₀ alkoxy group, or a halogen atom;
and p is an integer between 3 and 8, using an acid catalyst and water in the presence of an organic solvent.

6. The porous thin film according to claim 2, wherein the thermostable matrix precursor is a siloxane-based resin prepared by hydrolysis and condensation of a compound represented by Formula 3 below: 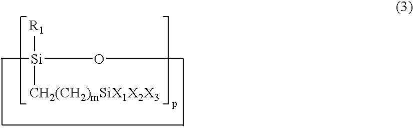
wherein R₁ is a hydrogen atom, a C₁-C₃ alkyl group, or a C₆C₁₅ aryl group; X₁, X₂ and X₃ are independently a hydrogen atom, a C₁-C₃ alkyl group, a C₁-C₁₀ alkoxy group, or a halogen atom, at least one of these substituents being a hydrolyzable functional group; m is an integer ranging from 1 to 10; and p is an integer ranging from 3to 8; or
Formula 4 below: 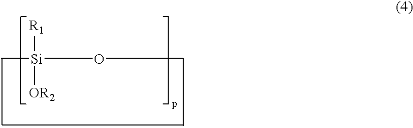
wherein R₁ is a hydrogen atom, a C₁-C₃ alkyl group, or a C₆-C₁₅ aryl group; R₂ is a hydrogen atom, a C₁-C₁₀ alkyl group, or SiX₁X₂X₃,
in which X₁, X₂ and X₃ are independently a hydrogen atom, a C₁-C₃ alkyl group, a C₁-C₁₀ alkoxy group, or a halogen atom;
and p is an integer between 3 and 8, using an acid catalyst and water in the presence of an organic solvent.

7. The porous thin film according to claim 1, wherein the content of the porogen is in the range of 0.1%-95% by weight, based on the sum of the amounts of the porogen and the matrix precursor.

8. The porous thin film according to claim 2, wherein the content of the porogen is in the range of 0.1%-95% by weight, based on the sum of the amounts of the porogen and the matrix precursor.

9. The porous thin film according to claim 1, wherein the content of the solvent in the composition is in the range of 20%-99.9% by weight.

10. The porous thin film according to claim 2, wherein the content of the solvent in the composition is in the range of 20%-99.9% by weight.

11. The porous thin film according to claim 1, wherein the solvent is selected from the group consisting of aromatic hydrocarbons, ketones, ethers, acetates, amides, γ-butyrolactone, alcohols, silicon solvents, and mixtures thereof.

12. The porous thin film according to claim 2, wherein the solvent is selected from the group consisting of aromatic hydrocarbons, ketones, ethers, acetates, amides, γ-butyrolactone, alcohols, silicon solvents, and mixtures thereof.

13. The porous thin film according to claim 11, wherein the solvent is selected from the group consisting of anisole, xylene, mesitylene, methyl isobutyl ketone, 1-methyl-2-pyrrolidinone, acetone, tetrahydrofuran, isopropyl ether, ethyl acetate, butyl acetate, propylene glycol monomethyl ether acetate, dimethylacetamide, dimethylformamide, γ-butyrolactone, isopropyl alcohol, butyl alcohol, octyl alcohol, silicon solvents, and mixtures thereof.

14. The porous thin film according to claim 12, wherein the solvent is selected from the group consisting of anisole, xylene, mesitylene, methyl isobutyl ketone, 1-methyl-2-pyrrolidinone, acetone, tetrahydrofuran, isopropyl ether, ethyl acetate, butyl acetate, propylene glycol monomethyl ether acetate, dimethylacetamide, dimethylformamide, γ-butyrolactone, isopropyl alcohol, butyl alcohol, octyl alcohol, silicon solvents, and mixtures thereof.

15. A semiconductor device comprising the porous thin film according to claim 1.

16. A semiconductor device comprising the porous thin film according to claim 2.
